(19) United States
(12) Patent Application Publication
(10) Pub. No.: US 2014/0368119 A1
(43) Pub. Date: Dec. 18, 2014

(54) LIGHT EMITTING DIODE LIGHTING APPARATUS AND DRIVING METHOD THEREOF

(71) Applicant: SAMSUNG ELECTRO-MECHANICS CO., LTD., Suwon (KR)

(72) Inventors: Yun Joong LEE, Suwon (KR); Deuk Hee PARK, Suwon (KR); Chan Woo PARK, Suwon (KR); Jong Tae HWANG, Suwon (KR); Je Hyeon YU, Suwon (KR); Soo Hyun MOON, Suwon (KR); Hye Jin LEE, Suwon (KR); Chang Seok LEE, Suwon (KR); Sang Hyun CHA, Suwon (KR)

(73) Assignee: SAMSUNG ELECTRO-MECHANICS CO., LTD., Suwon (KR)

(21) Appl. No.: 14/026,087

(22) Filed: Sep. 13, 2013

(30) Foreign Application Priority Data
Jun. 18, 2013 (KR) 10-2013-0069783

(51) Int. Cl. H05B 33/08

(52) U.S. Cl. CPC H05B 33/0848
USPC 315/200 R; 315/308; 315/307

(57) ABSTRACT

There is provide a light emitting diode lighting apparatus capable of being generally used in various kinds of dimmer, the apparatus including: a dimmer varying waveforms of input power according to a dimming signal; a bleeder adjusting a bleeding current under control; a controller comparing a latching current of the dimmer with the bleeding current of the bleeder to control the amount of the bleeding current; and an LED driver receiving a current other than the bleeding current flowing through the bleeder from among the currents from the dimmer to driver a light emitting diode (LED).

### CROSS-REFERENCE TO RELATED APPLICATIONS

This application claims the priority of Korean Patent Application No. 10-2013-0069783 filed on Jun. 18, 2013, in the Korean Intellectual Property Office, the disclosure of which is incorporated herein by reference.

### BACKGROUND OF THE INVENTION

1. Field of the Invention

The present invention relates to a light emitting diode lighting apparatus used in light emitting diode lighting apparatus using a bleeder, and a driving method thereof.

2. Description of the Related Art

Alight emitting diode (LED) is a semiconductor device that is configured in a p-n junction structure and emits light through the recombination of electrons and holes. Such an LED has come into widespread use as semiconductor technologies have recently evolved.

Among other, an LED is advantageous in that it is relatively more efficient and has a longer lifespan than existing light emitting apparatuses, and is environmentally-friendly; and, therefore, the application thereof is continually expanding.

In general, an LED is driven with a direct-current (DC) power source of several volts, and thus a means of conversion is required when an LED is driven with commonly available alternating-current (AC) power used in homes and offices.

In order to drive an LED with AC power, an LED driver typically includes a rectifying circuit, an AC-DC converter and the like.

In particular, in a lighting apparatus using an LED, a dimmer is used to control the lighting of the LED by converting an AC power source according to a dimming signal. Such a dimmer has a specified latching current (IL), a minimum current for turning the dimmer on and a specified holding current (IH), a minimum current for keeping the dimmer turned on.

The standards of such IL and IH are not set and they may be set differently from dimmer to dimmer.

In LED lighting apparatuses, light blinking or flickering may occur by misfires due to diode characteristics and capacitor characteristics of the LED and the driving circuit.

This may happen when a load of the LED lighting apparatus consumes a current lower than the IL or IH.

In order to address the flicker problem in the LED lighting apparatus, a bleeder may be employed in the LED lighting apparatus which provides an additional current path to meet the IL and IH requirements, as disclosed in Patent Document 1 below.

However, the LED lighting apparatus employing the bleeder may still have a problem in that it may be difficult to meet the requirements of various dimmers having different IL or IH specifications.

In order to overcome such a problem, the capacitance of capacitors or resistance of resistors used in the bleeder should be very large, which may have a negative influence on power utilization efficiency or a power factor. In particular, in a bleeder consisting of passive elements, inrush current may increase.

### RELATED ART DOCUMENT

(Patent Document 1) US Patent Laid-Open Publication No. 2011-0291583

### SUMMARY OF THE INVENTION

An aspect of the present invention provides a light emitting diode lighting apparatus capable of being generally used in various kinds of dimmer, and a driving method thereof.

According to an aspect of the present invention, there is provided a light emitting diode lighting apparatus, including: a dimmer varying waveforms of input power according to a dimming signal; a bleeder adjusting a bleeding current under control; a controller comparing a latching current of the dimmer with the bleeding current of the bleeder to control the amount of the bleeding current; and an LED driver receiving a current other than the bleeding current flowing through the bleeder from among the currents from the dimmer to driver a light emitting diode (LED).

The controller may compare the latching current of the dimmer with the bleeding current of the bleeder at the beginning of the operation.

The LED driver may be interrupted at the beginning of the operation.

The controller may include: a detector detecting a current level of a power from the dimmer; a comparator comparing the current level detected by the detector with a predetermined reference voltage; and a counter counting an output result from the comparator and setting the bleeding current of the bleeder to a lower value if 1 is counted.

The bleeder may include: a group of constant-current sources having a plurality of constant-current sources each providing a predetermined constant current; and a group of switches having a plurality of switches each providing a current path for a corresponding one of the constant-current sources under the control of the controller.

The apparatus may further include a rectifier rectifying the waveform-varied power from the dimmer.

According to another aspect of the present invention, there is provided a driving method of a light emitting diode lighting apparatus, including: turning the driving of a light emitting diode off; detecting a current from a dimmer and comparing the level of the detected current with the level of a predetermined reference voltage; and counting the comparison result and adjusting a bleeding current of a bleeder.

The adjusting of the bleeding current may include adjusting the bleeding current of the bleeding to a lower value if the comparison result is 1.

The adjusting of the bleeding current may include adjusting the bleeding current of the bleeding until the comparison result reaches 0.

The adjusting of the bleeding current may include maintaining the immediately previous bleeding current if the comparison result is 0.

The method may further include, upon completion of the adjusting of the bleeding current, turning the driving of the light emitting diode on.

The bleeding current may be set to have a maximum current value at the beginning of the operation.

The bleeding current may be set to have half of a maximum current value at the beginning of the operation.

The adjusting of the bleeding current may include: determining if the comparison result is 1 and storing the number; and if the comparison number reaches a predetermined maximum comparison number, setting the bleeding current of the bleeder by multiplying the number of operating constant-current sources of the bleeder plus one (N+1) by a current amount of the constant-current sources (Iu) if the counted number is 0, or setting the bleeding current of the bleeder by multiplying the number (N) of the operating constant-current sources of the bleeder by the current amount of the constant-current sources (Iu) if the counted number is greater than 0.

The adjusting of the bleeding current may include: if the comparison number fails to reach the maximum comparison number, checking the counted number; and adjusting the bleeding current of the bleeder to a higher value by increasing the number (N) of the operating constant-current sources of the bleeder if the counted number is 0, or adjusting the bleeding current of the bleeder to a lower value by decreasing the number of the operating constant-current sources of the bleeder if the counted number (K) is greater than 0.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram schematically illustrating a light emitting diode lighting apparatus according to an embodiment of the present invention;

FIG. 2 is a circuit diagram schematically illustrating the bleeder employed in the light emitting diode lighting apparatus shown in FIG. 1; and

FIGS. 3 and 4 are flowcharts each illustrating a driving method of a light emitting diode lighting apparatus according to an embodiment of the present invention.

### DETAILED DESCRIPTION OF THE INVENTION

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

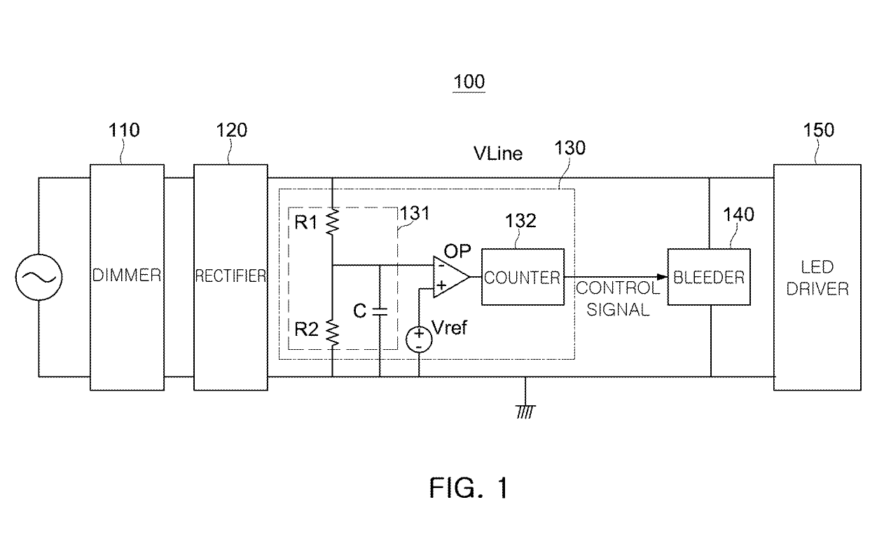

FIG. 1 is block diagram illustrating a light emitting diode lighting apparatus according to an embodiment of the present invention.

Referring to FIG. 1, the light emitting diode lighting apparatus 100 according to the embodiment of the present invention may include a dimmer 110, a rectifier 120, a controller 130, a bleeder 140 and an LED driver 150.

The dimmer 110 may adjust the brightness and color of lighting by varying waveforms of input power source according to a dimming signal. The input power source may be an alternating current power source.

The rectifier 120 may rectify the power source waveforms of which have been varied by the dimmer 110.

The controller 130 may include a detector 131, a comparator OP, a counter 132, and may compare the voltage level of the power source rectified by the rectifier 120 with a predetermined reference voltage Vref, so that it may adjust the bleeding current of the bleeder 140 based on the counts of output signals.

Specifically, the detector 131 may include voltage-dividing resistors R1 and R2 to divide and detect the voltage level of the power source from the rectifier 120, and the comparator OP may compare the divided voltage with the reference voltage Vref to output the comparison result.

The comparator OP may output 1 when the level of the divided voltage is above the level of the reference voltage Vref, and may output 0 when the level of the divided voltage is below the level of the reference voltage Vref.

The dimmer 110 may be interrupted when the current consumed in the bleeder 140, i.e., bleeding current, is below the level of the latching current of the dimmer 110.

Accordingly, the level of the reference voltage Vref may be set taking into account the detected latching current of the dimmer 110.

The counter 132 may count the outputs from the comparator OP to provide a corresponding control signal, and the bleeder 140 may adjust the bleeding current according to the control signal.

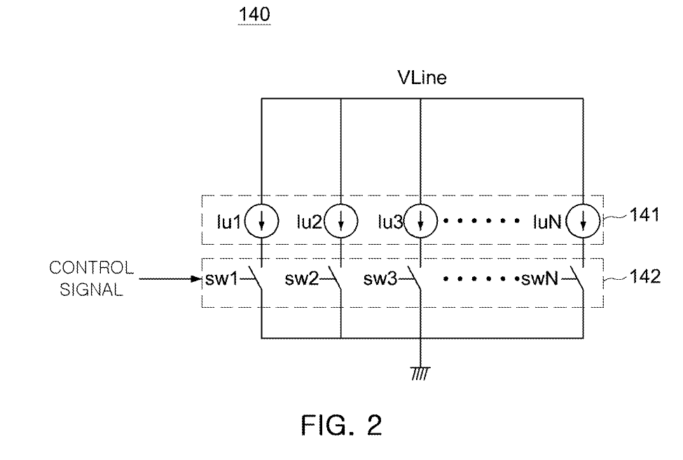

FIG. 2 is a circuit diagram schematically illustrating the bleeder employed in the light emitting diode lighting apparatus shown in FIG. 1.

The bleeder 140 may include a group of constant-current sources 141 and a group of switches 142.

The group of constant-current sources 141 may include a plurality of constant current sources lu1, lu2, lu3, . . . luN, each connected to a voltage source VLine in parallel.

The group of switches 142 may include a plurality of switches sw1, sw2, sw3, . . . swN, each connected to the respective constant-current sources in series and connected to the ground in parallel.

Each of the plurality of constant-current sources lu1, lu2, lu3, . . . luN, may allow a predetermined amount of current to flow from the voltage source VLine, and the plurality of switches sw1, sw2, sw3, . . . swN may be turned on or off according to a control signal to provide a current path so that currents from the plurality of constant-current source may flow.

For example, when it is desired to increase the amount of the bleeding current, a larger number of the switches are turned on, and when it is desired to decrease the amount of the bleeding current, a smaller number of the switches are turned on.

The LED driver 150 may drive a light emitting diode (LED) by using delivered power, and may be interrupted for a certain period of time for adjusting the bleeding current of the bleeder 140 to accurately adjust current, at initial stage of operation of the lighting apparatus.

After the normal operation, in some cases, current flowing through the bleeder 140 may be interrupted in order to increase power efficiency.

Hereinafter, a driving method of a light emitting diode lighting apparatus according to an embodiment of the present invention will be described.

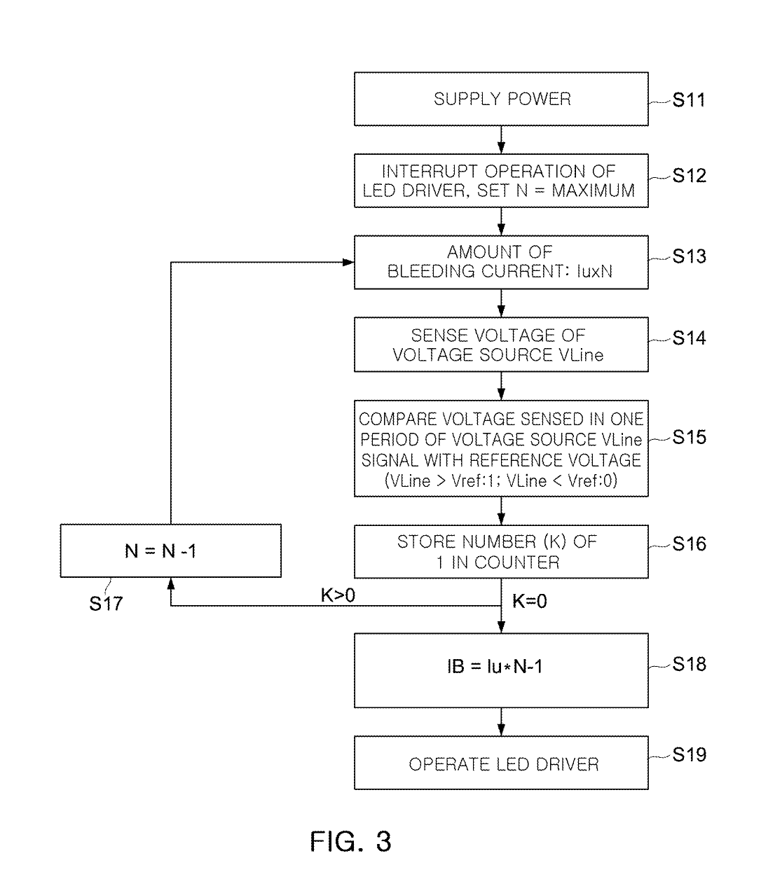

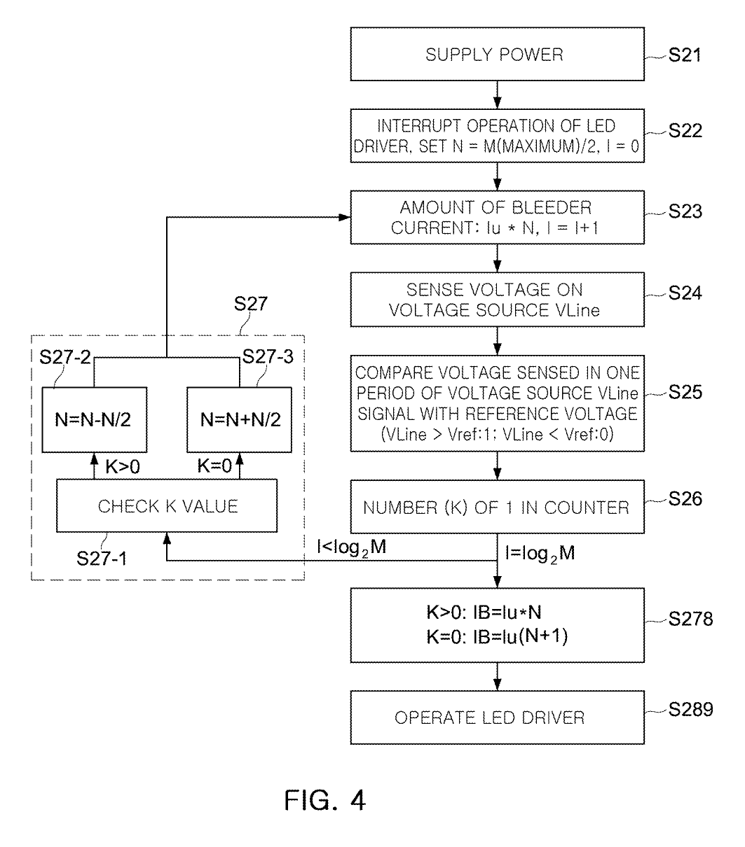

FIGS. 3 and 4 are flowcharts, each illustrating a driving method of a light emitting diode lighting apparatus, according to an embodiment of the present invention.

Referring to FIG. 3 in conjunction with FIG. 1, the driving method may include, when a power is supplied (S11), interrupting the operation of an LED driver 150 at the beginning of operating thereof, and setting the numbers of constant-current sources operating in the bleeder 140 to a maximum value (S12).

Here, the amount of the bleeding current of the bleeder 140 may be set by multiplying the current amount of each of the constant-current sources Iu by the number N of the operating constant-current sources (S13), such that the amount of the bleeding current may set to a maximum at the beginning.

Subsequently, the detector 131 and the comparator OP in the controller 130 may detect the current flowing through the voltage source VLine in voltage (S14), and detect the current during at least one period of the power input from the voltage source VLine in voltage to compare the detected voltage with the reference voltage Vref, to provide the comparison result to the counter 132 (S15).

The counter 132 may determine whenever the comparison result from the comparator OP is 1 and may store the number K (S16).

Here, if the counted number K is 0, the bleeding current of the bleeder 140 is set by multiplying the number of the previous operating constant-current sources N−1 by the current amount Iu of the constant-current sources (S18). If the counted number K exceeds 0, the bleeding current of the bleeder 140 is adjusted to a lower level by setting less number of operating constant-current sources N−1 (S17), and then the above-described operations of detecting voltage and determining may be repeated.

After an appropriate bleeding current is set, the LED driver 150 may be operated (S19).

The driving method described above may be called as a linear search scheme.

As a similar scheme, a SAR scheme is shown in FIG. 4.

Referring to FIG. 4 in conjunction with FIG. 1, when a power is applied (S21), the LED driver 150 is interrupted at the beginning, and the number of operating constant-current sources of the bleeder 140 may be set to have half of a maximum M (S22 and S23). Here, the comparison number I may be set to be 0.

The amount of the bleeding current of the bleeder 140 may be set by multiplying the current amount of each of the constant-current sources Iu by the number N of the operating constant-current sources, such that the amount of the bleeding current may set to the half of a maximum at the beginning. The comparison number I may be determined as 1.

Subsequently, the detector 131 and the comparator OP in the controller 130 may detect the current flowing through the voltage source VLine in voltage (S24), and detect the current during at least one period of the power input from the voltage source VLine in voltage to compare the detected voltage with the reference voltage Vref, to provided the comparison result to the counter 132 (S25).

Next, the counter 132 may determine whenever the comparison result from the comparator OP is 1 and may store the number K (S26). When the comparison number I reaches the maximum comparison number log₂M, if the counted number K is 0, then the bleeding current IB of the bleeder 140 may be set by multiplying the number of the operating constant-current sources plus one (N+1) by the current amount Iu of the constant-current sources, or if the counted number Kis greater than 0, then the bleeding current IB of the bleeder 140 may be set by multiplying the number of the operating constant-current sources N by the current amount Iu of the constant-current sources.

A more detailed description on the comparison number I and the maximum comparison number log₂M is given below.

For instance, assuming that the maximum current value is 16, if the current value of the dimmer is greater than bleeding current of the bleeder 140 by fourteen operating constant-current sources Iu*14 and less than the bleeding current of the bleeder 140 by fifteen operating constant-current sources, by repeating the comparison according to the SAR scheme, the number N of the constant-current source is increased to 8, 12 and 14, up to 15. Here, since the counted number K is 1, the bleeding current IB may be set to Iu*15.

If the current value of the dimmer is greater than bleeding current of the bleeder 140 by one operating constant-current sources Iu*1 and less than the bleeding current of the bleeder 140 by two operating constant-current sources, by repeating the comparison according to the SAR scheme, the number N of the constant-current source is decreased to 8, 4 and 2, down to 1. Here, since the counted number Kis 0, the bleeding current IB may be set to Iu*2.

If the comparison number I fails to meet the maximum comparison number log₂M (S27), the counted number K may be checked (S27-1).

Here, if the counted number K equals 0, the bleeding current of the bleeder is adjusted to a higher level by increasing the number N of the operating constant-current sources (S27-3). If the counted number K exceeds 0, the bleeding current of the bleeder 140 is adjusted to a lower level (S27) by setting a lower number of operating constant-current sources (S27-2), and then the above-described operations of detecting voltage and counting may be repeated.

After an appropriate bleeding current is set, the LED driver 150 may be operated (S29).

Although not shown, it may be also possible to set the amount of the bleeding current to a minimum value, determine whenever the comparison result from the comparator OP is 0 to store the number K, and increase the number of the operating constant-current sources.

However, in view of the fact that the dimmer 110 is interrupted when the current of a load is below the latching current, it may be desirable to set the amount of the bleeding current to a maximum, reduce the number of the operating constant-current sources to scan the latching current of the dimmer 110, and to adjust the bleeding current to appropriately reduce power consumption.

As set forth above, according to the embodiments of the present invention, the LED driver circuit is interrupted, the current flowing though the bleeder is adjusted according to the latching current of the dimmer to set the bleeding current, and then the LED driving circuit is operated, such that the present invention may be generally applied to various dimmers having different latching current (IL) or holding current (IH) specification.

As set forth above, according to embodiments of the present invention, current flowing through a bleeder is adjusted according to the latching current of a dimmer, such that a light emitting diode lighting apparatus can be generally used in various kinds of dimmer.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode lighting apparatus, comprising:
a dimmer varying waveforms of input power according to a dimming signal;
a bleeder adjusting a bleeding current under control;
a controller comparing a latching current of the dimmer with the bleeding current of the bleeder to control the amount of the bleeding current; and
an LED driver receiving a current other than the bleeding current flowing through the bleeder from among the currents from the dimmer to driver a light emitting diode (LED).

2. The apparatus of claim 1, wherein the controller compares the latching current of the dimmer with the bleeding current of the bleeder at the beginning of the operation.

3. The apparatus of claim 1, wherein the LED driver is interrupted at the beginning of the operation.

4. The apparatus of claim 1, wherein the controller includes:
a detector detecting a current level of a power from the dimmer;
a comparator comparing the current level detected by the detector with a predetermined reference voltage; and
a counter counting an output result from the comparator and setting the bleeding current of the bleeder to a lower value if 1 is counted.

5. The apparatus of claim 1, wherein the bleeder includes:
a group of constant-current sources having a plurality of constant-current sources each providing a predetermined constant current; and
a group of switches having a plurality of switches each providing a current path for a corresponding one of the constant-current sources under the control of the controller.

6. The apparatus of claim 1, further comprising a rectifier rectifying the waveform-varied power from the dimmer.

7. A driving method of a light emitting diode lighting apparatus, comprising:
turning the driving of a light emitting diode off;
detecting a current from a dimmer and comparing the level of the detected current with the level of a predetermined reference voltage; and
counting the comparison result and adjusting a bleeding current of a bleeder.

8. The method of claim 7, wherein the adjusting of the bleeding current includes adjusting the bleeding current of the bleeding to a lower value if the comparison result is 1.

9. The method of claim 8, wherein the adjusting of the bleeding current includes adjusting the bleeding current of the bleeder until the comparison result reaches 0.

10. The method of claim 9, wherein the adjusting of the bleeding current includes maintaining the immediately previous bleeding current if the comparison result is 0.

11. The method of claim 7, further comprising, upon completion of the adjusting of the bleeding current, turning the driving of the light emitting diode on.

12. The method of claim 7, wherein the bleeding current is set to have a maximum current value at the beginning of the operation.

13. The method of claim 7, wherein the bleeding current is set to have half of a maximum current value at the beginning of the operation.

14. The method of claim 13, wherein the adjusting of the bleeding current includes:
determining if the comparison result is 1 and storing the number; and
when the comparison number reaches a predetermined maximum comparison number, setting the bleeding current of the bleeder by multiplying the number of operating constant-current sources of the bleeder plus one (N+1) by a current amount of the constant-current sources (Iu) if the counted number is 0, or setting the bleeding current of the bleeder by multiplying the number (N) of the operating constant-current sources of the bleeder by the current amount of the constant-current sources (Iu) if the counted number is greater than 0.

15. The method of claim 14, wherein the adjusting of the bleeding current includes:
if the comparison number fails to reach the maximum comparison number, checking the counted number; and
adjusting the bleeding current of the bleeder to a higher value by increasing the number (N) of the operating constant-current sources of the bleeder if the counted number is 0, or adjusting the bleeding current of the bleeder to a lower value by decreasing the number of the operating constant-current sources of the bleeder if the counted number (K) is greater than 0.
